(19) United States
(12) Patent Application Publication
(10) Pub. No.: US 2026/0003941 A1
(43) Pub. Date: Jan. 1, 2026

(54) SYSTEMS AND METHOD FOR STRUCTURE ENABLED, MODEL DRIVEN, CHANNEL INTEGRATION AND DISPATCH

(71) Applicant: WELLS FARGO BANK, N.A., San Francisco, CA (US)

(72) Inventors: Prathamakshari Kote, Concord, NC (US); Dmitry Sukner, Brooklyn, NY (US); Niraj Pandey, Edison, NJ (US)

(21) Appl. No.: 18/754,334

(22) Filed: Jun. 26, 2024

(51) Int. Cl. G06F 21/31

(52) U.S. Cl. CPC G06F 21/31

(57) ABSTRACT

Systems and methods for structure enabled, model driven, channel integration and dispatch including: receiving, from a messaging client, model data; receiving from a template database a structured template, the template database comprising one or more templates that each comprise a static data element, a dynamic data element, and a channel configuration data element; generating a channel-specific message by applying the model data to the structured template; and transmitting, to a service associated with the channel configuration data element, the channel-specific message.

### FIELD OF INVENTION

The present disclosure generally relates to message dispatch automation, and more particularly to systems and methods for using structure enabled, model driven, channel integration and dispatch for providing scalable, automated transmission of messages across different channels and service environments.

### BACKGROUND

Existing Application Programming Interface (“API”) integration solutions lack a unified standard approach for seamlessly connecting various channels and service APIs when such APIs have varying configurations. For instance, varying API data structures, formatting requirements, or mapping requirements typically require special configuration of the various API channels and services. Backend developers are often burdened with the complex task of manually maintaining working configurations between different API channels and services. In addition to labor and burden costs, maintaining working configurations between applications, channels, and services may lead to errors, obsolescence, and other inefficiencies. Moreover, handling API formatting with dynamic content at each application level poses another risk of non-uniformity and non-compliance between API channels.

### SUMMARY

In an aspect, an example method includes receiving, from a messaging client, model data; receiving from a database, a structured template, the database comprising one or more templates that each comprise a static data element, a dynamic data element, and a channel configuration data element; generating a channel-specific message by applying the model datafile to the structured template; and transmitting, to a service associated with the channel configuration data element, the channel-specific message.

In a further aspect, further example methods include outputting the channel-specific message to a graphical user interface.

In a further aspect, further example methods include receiving a modification request, wherein the modification request includes a modification to one or more of the static data element, the dynamic data element, or the channel configuration data element of the one or more templates; generating a custom template based in part on the modification request; and deploying the custom template in the database.

In a further aspect, further example methods include receiving an application associated with an application owner; and providing, to the application owner, client user access permissions.

In a further aspect, further example methods include prior to deploying the custom template in the database: displaying a preview of the custom template; and receiving approval to deploy the custom template in the database.

In a further aspect, the channel configuration data element includes channel-identifier data, and the method further includes receiving the structured template from the database is based in part on the channel-identifier data.

In a further aspect, generating the channel-specific message comprises retrieving, from the model data, target variable data, and inserting the target variable data into the dynamic data element.

In a further aspect, generating the channel-specific message further comprises modifying the target variable data based in part on the channel configuration data element to generate modified target variable data; and inserting the modified target variable data into the dynamic data element.

In a further aspect, the structured template further includes a data formatting element; and generating the channel-specific message includes modifying the model data based in part on the data formatting element.

In a further aspect, the messaging client generates an API call, and the API call generates the model data.

The above methods can be implemented as computer-executable program instructions stored in a non-transitory, tangible computer-readable medium or media and/or operating within a processor or other processing device and memory.

### BRIEF DESCRIPTION

A full and enabling disclosure is set forth more particularly in the remainder of the specification. The specification makes reference to the following appended figures.

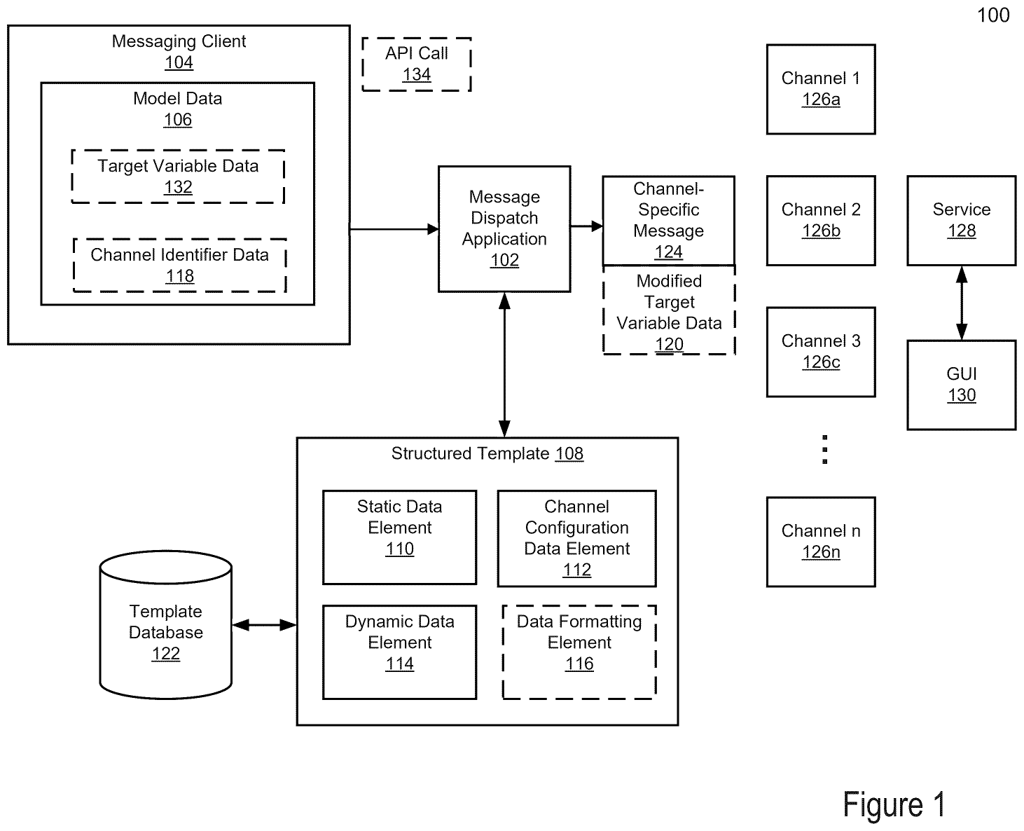

FIG. 1 illustrates a system for message dispatch.

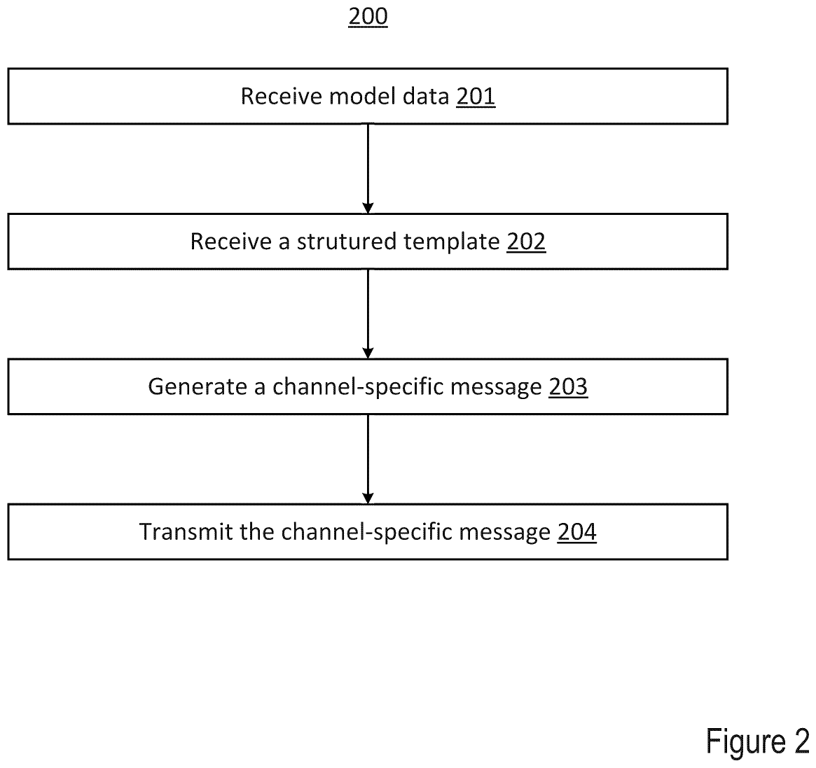

FIG. 2 illustrates a flow chart for a method of dispatching messages.

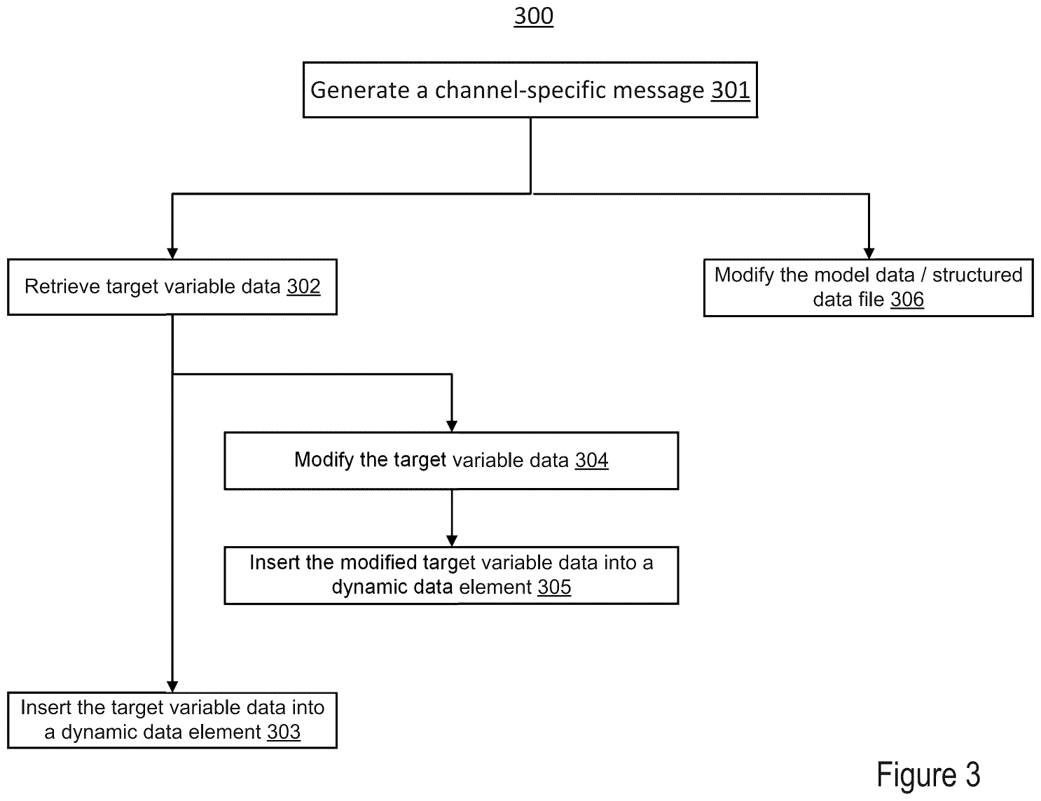

FIG. 3 illustrates a flow chart for a method of generating channel-specific messages.

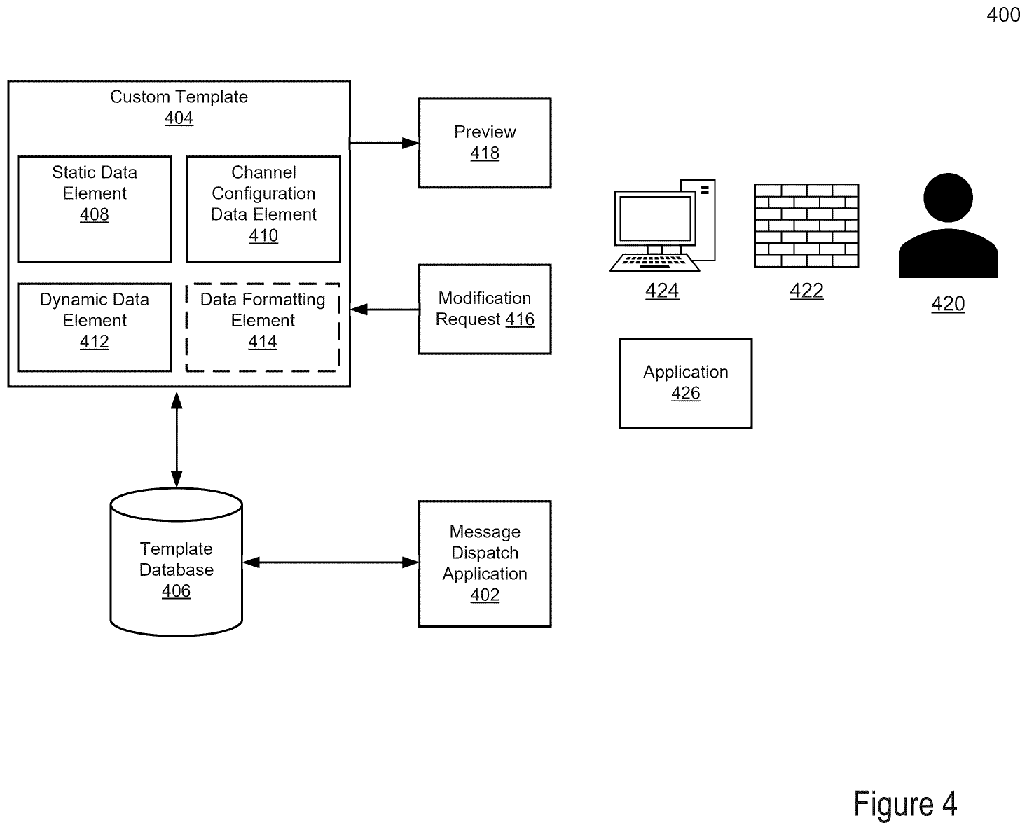

FIG. 4 illustrates a system for generating and storing templates for operation with the message dispatch application.

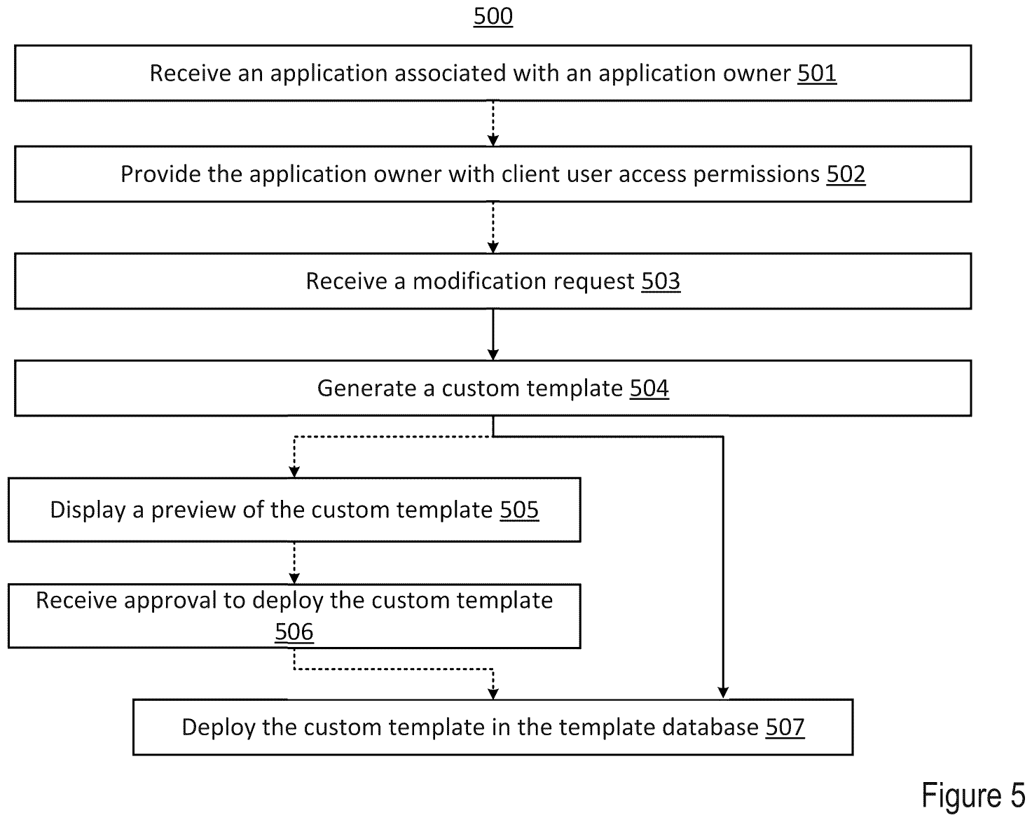

FIG. 5 illustrates a flow chart for a method of generating and deploying custom templates.

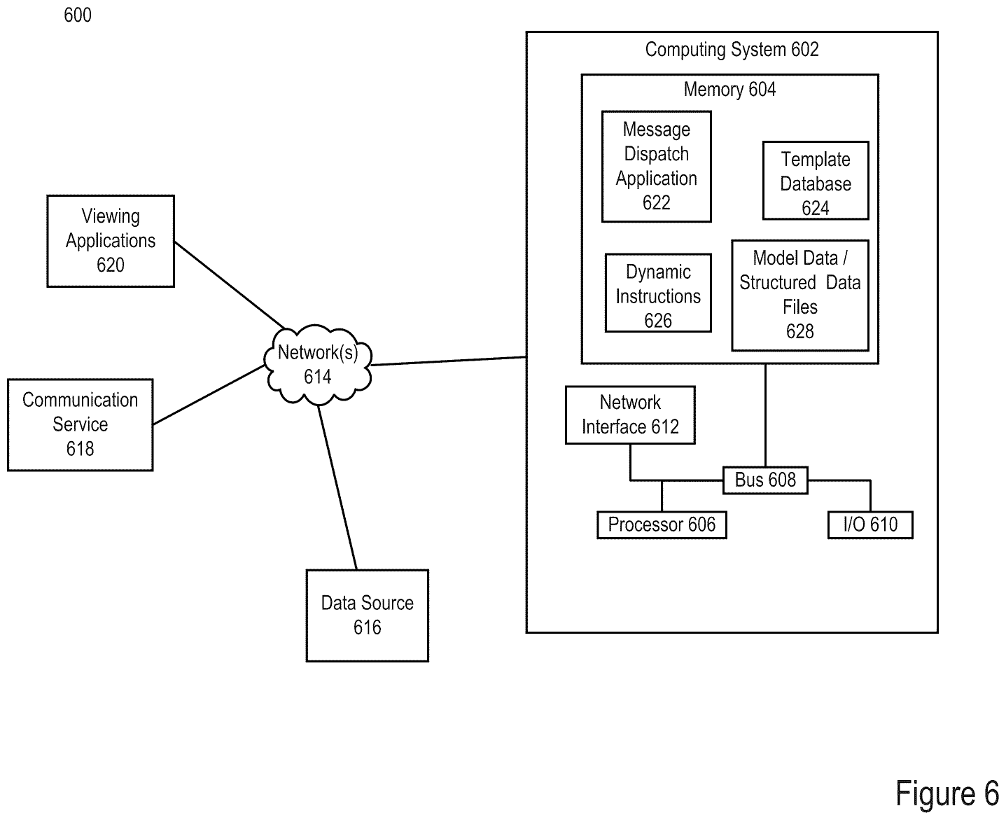

FIG. 6 illustrates a block diagram for an example computing environment capable of executing the described systems and methods.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of a System for Message Dispatch

In one illustrative embodiment, a system for message dispatch includes an application for generating and transmitting channel-specific messages to associated services. The application may be part of a larger enterprise application infrastructure or existing API management system. The application may provide a user interface to allow client users, such as software developers and administrators to send messages across a variety of channels and services through a common, single user interface or same API.

The application can receive any other form of data-driven request to transmit data such as a message to one or more channels. For instance, the application may receive an API call to send a message, where the API call includes dynamic data. The application can decompose the API call and reprocess it into a specific channel message. The API call, or any other request received by the application may for instance include model data, such as a Java-Script Open Notation (“JSON”) file, key value pair data, or any other hierarchical or structured form of data. The model data may be created by a user such as a client application owner. The user may be able to configure the model data through a messaging client initiating the API call to include, for instance, domain specific names, that are unique to the messaging client interface. As a result, the user would not have to worry about or sync to the channel-specific data names unique to the interface of each channel. Instead, the messaging client, initiating the API call, would provide a more familiar interface for the user to communicate to the specific channels.

In one example, the application receives a request from another application to transmit incident reports. The incident reports may be recurring data generated by another application that must be sent out to a set of recipient users across a variety of channels such as through email, system communication channels including Microsoft Teams, Jira, Slack, or any other channel for communication. The application initiating the request generates an API call that is received by the message dispatch application. The request for instance is in the form of a JSON file.

The model data received by the application can include dynamic data. Dynamic data may be any data that changes between recipient users or that changes between a target channel. In the incident report example, the requesting application may request a unique incident report be sent a set of recipient users. The unique incident report may then be the dynamic data that changes between each target recipient.

Once the message dispatch application receives the request to transmit the message to the recipient users, the dispatch application may process request data and associate the data with a template to create a channel-specific message. The template may be a data structure including various forms of data such as a static data element, dynamic data element, or a channel configuration data element. The template may be one of a variety of templates stored in a template repository or database. As will be described in further examples, the dispatch application may provide a template creation user interface to allow specific users of the dispatch application to create and store templates within the template database. The template may store programmable logic configuring a processor to automatically process data in the form of model data received by the requesting application and generate channel-specific messages for transmission to recipient users through a specified graphical user interface.

In the incident report example, an application user may select a specific template from the database to associate with specific incident report generated by an incident report application. The structured template may store channel configuration data that causes the incident report messages to be transmitted to services such as email and text-based messaging software. After selection of a template, the incident report application will send an incident report to the message dispatch application. The message dispatch application will then retrieve the structured template, and then generate channel-specific messages decomposed from the initial incident report. The channel-specific messages will then be transmitted to the specific channels and services as identified by the template.

In the preceding incident report example, the application user tasked with transmitting the incident report message is able to use the model-driven template to communicate through one or more channels. Specifically, the application user is able to avoid manually configuring messages to each specific channel, service, and associated API. Instead, the application user may choose from any variety of templates to configure the message dispatch application to automatically transmit messages once received by the incident report application. Further, the application user can configure the message dispatch application through use of other templates to transmit messages received by any other application, per the rules configured within an associated template.

### Illustrative Example of a System and Interface for Generating and Storing Templates

In one illustrative example, the message dispatch application may receive and process user requests to create and configure new templates that are to be stored and deployed within the template database for user selection and system integration. The users requesting modifications to templates may be the same or different users compared to those selecting the templates for use in the message dispatch application.

In one example, the users requesting modifications to the templates are client users with privileged access to create and modify templates within the template database. Only client users, for instance, may be allowed to create or modify templates. Application developers, or those that create applications that are capable of integration with the message dispatch application, may be client users provided privileged access to create templates associated with their application. The application developers may also delegate specific users to have similar client user privilege to modify the templates.

The message dispatch application may be multi-tenant in that it can be paired with any variety of message requesting application that transmit message requests to the message dispatch application. In the above described examples, the incident report application may be paired with the message dispatch application such that the incident report application can send channel-specific messages through the message dispatch application template configurations. The owner, or other privileged user of the incident report application may be granted client user access to modify templates associated the incident report application. Owners of other applications that are paired with the dispatch application program may similarly be given privileged access to create and modify templates associated with their respective application but may not be given privileged access to create or modify templates associated with the incident report application.

As another example of a messaging client application that may pair with the message dispatch application, a password update application may generate unique passwords for recipient users. The password update application owner may modify templates associated with the password update application so that password updates are transmitted to specific users by one or more specified channels. Like the owner of the incident report application, the owner or manager of the password update application may be granted permission to modify or create templates associated with the password update application but would not be granted permission to modify other templates stored in the template database.

Client users with privileged access to the template database may be able to customize templates associated with specific messaging applications. The customization process may entail the client user selecting a default, reference template from a collection of default, reference templates in the template database. The default templates may range in complexity. A less complex template may include a static element, a dynamic element, and basic channel-configuration data that would specify a single channel or service that associated messages would be transmitted to. A more complex template may include multiple static elements, multiple dynamic elements, and more complex channel-configuration data that would specify multiple channels and services to transmit associated messages to. The templates may be customized to include formatting data that creates unique formatting of text or image elements, that may be displayed differently depending on the channel-configuration data. Generally, the templates may store logical statements and metadata that are used to dictate how messages are transmitted and presented across one or more channels and graphical user interfaces.

### Example System for Message Dispatch

FIG. 1 illustrates a system for message dispatch. The system includes a message dispatch application 102. The system 100 further includes a messaging client 104, a template database 122 for storing one or more templates, and a service 128 capable of receiving channel-specific messages 124 generated by the message dispatch application 102. In some examples, the message dispatch application 102, the messaging client 104, channels 126a-126n, and the service 128, among other components of FIG. 1, may operate on different cloud service provider infrastructure.

The message dispatch application 102 can receive data, including model data 106, from one or more messaging clients 104. The messaging clients 104 can be any application that generates requests for sending to a service 128 for display to a graphical user interface 130. The messaging client may generate the request by an API call 134. Examples of messaging clients 104 may include an application that generates incident reports. The incident reports may be required to be sent out to one or more recipient users among different channels periodically. As another example, the messaging client 104 can be an application that generates new passwords to be sent out to different users across different services. Other applications may communicate with the message dispatch application 102 and may generally initiate requests through the message dispatch application 102. The request may be initiated, for instance, by an API call 134 generated by the messaging client 104 and transmitted to the message dispatch application 102. The API call 134 and the data therein may be determined or provided by a user interfacing through the messaging client 104 and message dispatch application 102. The user, messaging client 104 and message dispatch application 102 can continue to use such interfaces and organization including the names and the structures without needing to adjust to the interface and configurations of any specific channel.

The messaging client 104 can transmit to the message dispatch application, model data (also referred to as structured data files). 106. Model data 106 generally includes a structured format of data, for instance, JSON files storing one or more data elements in a hierarchical structure. The model data 106 can include other structure data types, such as key-value paired data, YAML data, XML data or HTML data. Model data 106 may similarly be referred to as “model data” or “modal data” to indicate that the model data 106 provide the input for generating a channel-specific message. The model data 106 can include, among other data, channel identifier data 118. The channel identifier data 118 includes an identification of one or more channels, e.g. channels 126a-126n, for a message to be sent to.

The message dispatch application 102 may also receive or retrieve a structured template 108 (also referred to as a selected template) from a template database 122. Each template stored in the template database 122 can include static data elements 110, channel configuration data elements 112, dynamic data elements 114, and data formatting elements 116. More or fewer elements may be present for each of the templates stored in the template database 122.

Static data elements 110 can be elements of a template that may not change between channels, services, or recipient users. Examples of static data elements 110 can include branding information or other letterhead, and boilerplate language. In the incident report example, the static element can include language stating, “Incident Report,” or the brand logo of the client application initiating the message.

Dynamic data elements 114 can be elements of the template that change between channels, services, or recipient users. As part of the template, the dynamic data element 114 includes a placeholder data entry point, which is later overwritten or otherwise modified to store data received from the model data. Examples of dynamic data elements 114 include data that changes in relation to the channel by the which the message is to be sent, or data that changes based on the recipient user who is to receive a message. For instance, in the incident report example, the dynamic data elements 114 can include a placeholder for receiving the incident number received from the model data 106. In the password management example, the dynamic data elements 114 can include placeholders for username and password as received from the model data 106. The dynamic data elements 114 may also include programmable logic that determines what data to retrieved from the model data 106 for input into the placeholder template.

Channel configuration data elements 112 can be elements that store programmable logic indicating to the template how to parse the model data 106 based on the channel identifier data 118. For instance, a client user, with access to creation of templates, may create programmable logic for each template for cooperation with the channel identifier data 118 of the model data 106. Then, when the message dispatch application 102 receives a structured data file (model data) 106 with specific channel identifier data 118, the message dispatch application may select a template 108 based on the associated channel configuration data element 112. In this way, the message dispatch application 102 can receive model data 106 and automatically create a channel-specific message 124 based in part on the channel configuration data element 112 of a given template. When the message dispatch application 102 then selects a template 108, the message dispatch application 102 can configure the received model data 106 for proper arrangement and display on a graphical user interface 130 based in part on the programmable logic stored within the channel configuration data element 112.

In some examples, templates can include data formatting elements 116. Data formatting elements 116 may include additional logic used by the message dispatch application 102 to generate channel-specific messages. Data formatting elements 116 can include font size and selection, image size and selection, and additional programmable logic that alters the model data. For instance, the data formatting element 116 may include a rule to automatically bolden parts of the model data 106 that are incorporated into the dynamic data element 114. In the incident report example, the data formatting element 116 of a given template may indicate to bolden the incident report number as received from the model data 106 for input into the channel-specific message 124.

The message dispatch application 102 can receive or retrieve a template from the template database 122 for operation with model data 106. For example, the message dispatch application 102 may first receive a structured data file (model data) 106 from a messaging client 104, for instance by an API call 134. The model data 106 may include channel identifier data 118 that the message dispatch application uses to select a template 108 from the template database 122. The message dispatch application 102 may then retrieve the structured template 108 and merge the structured template 108 with the received model data 106 to generate a channel-specific message 124. Merging the model data 106 may be based in part according to the logic of the channel configuration data element 112. For instance, the model data 106 may include target variable data 132. The message dispatch application 102, upon receiving the model data 106 from the messaging client 104, and upon receiving the associated structured template 108 can generate a channel-specific message 124 including modified target variable data 120. The modified target variable data 120 may comprise the target variable data 132, modified according to logic stored within the structured template 108.

The channel-specific message 124, generated by the message dispatch application 102, may include portions of the model data 106 formatted to fit the structured template 108. In the example of FIG. 1. the channel-specific message 124 may be associated with one or more channels 126a-126n. Channels 126a-126n may be API channels or other forms of communication linking the messaging client 104 with specific services 128. For instance, each channel 126a-126n may be associated with a specific service 128.

Services, such as service 128, may include communication applications such as an email service, messaging platform, chat channel, or other application for receiving and sending communications. Services may be displayed to users through graphical user interfaces 130. graphical user interfaces may for instance include mobile or computer devices capable of hosting and displaying services 126.

### Example Method for Message Dispatch

FIG. 2 illustrates a flow chart 200 for a method of dispatching messages. The flow chart 200 illustrates how the message dispatch application may generate and transmit channel-specific messages based in part on receiving model data according to aspects of the disclosure. Other examples may include more operations, fewer operations, different operations, or a different order of the operations shown in FIG. 2.

At step 201, the message dispatch application 102 receives model data 106 from a messaging client 104. The messaging client 104 can be any application capable of transmitting model data 106 to the message dispatch application 102. For instance, custom built software regularly generating message requests to be sent out to a variety of recipient users may automatically generate message requests in the form of model data. In an example, a messaging client 104 in the form of an alert application generates specific alerts to be sent to recipient users by email and through text. The messaging client 104 generates the alert as model data 106 to be sent to the message dispatch application 102. Model data can be of any format such as JSON files, key-pair files, XML files, or other filetypes. Generally, the model data will be hierarchically organized with nested classes of data for processing by the message dispatch application. In many examples, the model data are JSON files. The model data 106 may include channel identifier data 118 among other data such as the payload or message data to be displayed on a graphical user interface 130.

At step 202, the message dispatch application 102 receives a structured template 108 from the template database 122, The structured template 108, along with other templates stored in the template database 122 may include a static data element 110, a dynamic data element 114, and a channel configuration data element 112. In some examples, the message dispatch application 102 retrieves the structured template 108 based in part on data contained from the received model data 106. For instance, the channel identifier data 118, or other metadata included in the model data 106 may include an identifier that causes the message dispatch application 102 to receive or retrieve the structured template 108.

At step 203, the message dispatch application 102 generates a channel-specific message 124 by processing the model data 106 according to the rules of the structured template 108. In some examples, the structured template includes data elements 110-116 and logic that cause the message dispatch application 102 to perform specific operations in generating the channel-specific message 124. For instance, the structured template 108 may have a channel configuration data element 112 that indicates to the message dispatch application 102 which channel among the one or more channels the message is to be sent through. Similarly, the dynamic data element 114 may include a placeholder location to be overwritten by portions of the model data 106. The dynamic data element 114 may further include logic that identifies which portion of the model data 106 to retrieve for overwriting the placeholder of the dynamic data element 114. Data formatting element 116 may similarly include logic causing the message dispatch application 102 to reformat the dynamic data element 114 or static data element 110 of the generated channel-specific message 124.

In some examples, the channel configuration data element 112 and the data formatting element 116 are used in combination to cause the message dispatch application 102 to reformat the model data 106 into channel-specific message 124 that is readable by the graphical user interface 130. The logic stored between the channel configuration data element 112 and the data formatting element 116 may thereby allow a user of a messaging client to bypass manual formation of channel-specific messages after the creation of an associated template as stored in the template database 122.

At step 203, the message dispatch application 102 generates a channel-specific message 124 by applying the model data 106 to the structured template 108. As discussed with respect to step 202, the template data elements 110-116 may store logic that causes the message dispatch application 102 to generate specific configurations of the channel-specific message 124.

At step 204, the message dispatch application 102 transmits the channel-specific message 124 to a service 126 associated with the channel configuration data element 112. In some examples, the structured template may 108 include multiple channel configuration data elements 112 thereby causing the message dispatch application 102 to transmit the channel-specific message across multiple channels 126a-126n to multiple services.

FIG. 3 illustrates a flow chart for a method of generating channel-specific messages. The flow chart 300 illustrates how the message dispatch application may generate channel-specific messages based in part on receiving model data 106 according to aspects of the disclosure. Other examples may include more operations, fewer operations, different operations, or a different order of the operations shown in FIG. 3.

At step 301, the message dispatch application generates a channel-specific message by applying the model data to the structured template. Steps 302-303, 304-305, and 306 illustrate example methods of how the generation step 301 may be further performed. Steps 302-303, 304-305, and 306 may be performed in the same or separate generation processes.

At step 302, the message dispatch application retrieves target variable data 132 from the model data 106. As an example, logic stored within the dynamic data element 114 may configure the message dispatch application 102 to identify the target variable data 132. Then, at step 304, the message dispatch application 102 can insert the target variable data 132 into the dynamic data element 114, for instance, in a placeholder component of the dynamic data element 114. The steps 302-304 can provide a means for identifying the target variable data 132 and inserting the target variable data 132 into the channel-specific message 124.

Steps 304 and 305 may be performed by the message dispatch application 102 in addition to or alternatively to steps 302 and 303. At step 304, the message dispatch application 102 can modify target variable data 132 of the model data 106 based in part on the channel configuration data element 112 to generate modified target variable data 120. Like the dynamic data element 114, the channel configuration data element 112 may store pre-programmed logic unique to the structured template 108 that causes the message dispatch application 102 to modify the target variable data 132. Modifying the target variable data 132 can include converting the underlying data format of the received target variable data 132 to a format readable according to a specific channel or service 128.

At step 305, the message dispatch application 102 can insert the modified target variable data 120 into the dynamic data element 114. The modified target variable data 120 may be inserted into a designated placeholder of the template to in part format the channel-specific message 124.

Step 306 is another example method further illustrating generating a channel-specific message. At step 306, the message dispatch application can modify the model data 106 based in part on a data formatting element 116 included in the structured template 108. Each of the templates stored in the template database 122 can include a data formatting element 116. The data formatting element 116 can include programmed logic and instructions related to formatting the channel-specific message 124. For instance, the logic may include bolding or underlining specific words or other target variable data 132. The logic within the data formatting element 116 may be channel specific and may share logic with the channel configuration data element 112 so that the formatting of model data 106 may vary based on the associated channel and service 128.

### Example System and Interface for Generating and Storing Templates

FIG. 4 illustrates a system 400 for generating and storing templates for operation with the message dispatch application 402. In the example of FIG. 4, the message dispatch application 402 can communicate with a client user 420 to generate custom templates 404 for storage in the template database 406 for later retrieval and use by the message dispatch application 402. The modifications can include modifications to the static data element 408, the channel configuration data element 410, the dynamic data element 412, the data formatting element 414, or any other element stored within a template.

To modify a template within the template database 406, the message dispatch application can receive a modification request 416, for instance, by a request received from a graphical user interface associated with the message dispatch application. The modification request 416 may be made with respect to a default template already stored in the template database 406. For instance, a client user 420 may select a default template from the template database 406 and may wish to modify the template for operation with a specific application 426 or channel configuration. The client user 420 may then initiate a modification request 416 through an interface 424 of the message dispatch application 402.

In some examples the interface 424 can generate a preview 418 of the custom template 404 for display on a graphical user interface associated with the message dispatch application, and for review by the client user 420 prior to deployment into the template database 406. The preview 418 may provide a look and feel for how the custom template generates a channel-specific message to be displayed a on a service. In some examples, the interface 424 displaying the preview 418 may emulate the service associated with which channel-specific message generated by the custom template 404. The preview 418 can be generated in real-time wherein any modification request 416 to any of the elements 408-414 is displayed back to the client user 420 upon entry of the modification request 416. In this way, the message dispatch application 402 can provide the client user 420 with an efficient interface for previewing the generation of channel-specific messages emulated on services, as generated by the custom template 404 modified by the client user 420.

The client user 420 can be one or more users and may be filtered by the message dispatch application 402. Access filter 422 illustrates that, in some examples, access to the customizing templates is dependent on the status of the user requesting access to modify the template. For instance, the owner of an application 426 that is integrated with the message dispatch application 426 may be granted permission to modify or generate custom templates 404 related to that application 426 only. Applications 426 generally can refer to any application, such as a messaging client that interacts with the message dispatch application 402, for instance by an API call. The owner of the application 426 may automatically be granted client user access by the access filter 422 to customize templates associated with the application 426. Additionally, the owner can delegate to other users client user access to generate and modify custom templates 404.

In some examples, the message dispatch application 402 is a multi-tenant system capable of interacting with a variety of applications 426, for instance, by API calls. Thus, the template database 406 can store custom templates 404 associated with a variety of applications 426. In instances where the message dispatch application 402 hosts multiple applications 426 with different owners, the access filter 422 may be configured to grant respective client user access permissions to each owner and user delegated by the owner. A first application owner may be permitted access to generate and customize templates associated with the application which they own but be denied access to modify templates associated with other applications.

### Example Method for Generating and Storing Templates

FIG. 5 illustrates a flow chart 500 for a method of generating and deploying custom templates. The flow chart 500 illustrates how the message dispatch application 402 may generate custom templates 404 according to the disclosure. Other examples may include more operations, fewer operations, different operations, or a different order of the operations shown in FIG. 5. For example, in some examples, steps 501-502 may or may not be performed while steps 503, 504 and 507 are performed. Any combination of the shown steps may be performed according to different embodiments.

At step 501, the message dispatch application 402 receives an application 426 associated with an application owner. The application 426 can be a messaging client application configured to generate messages including model data for transmission to one or more services. The message dispatch application 402 may receive the application through code integration or installation of the application 426 for operation with the message dispatch application 402. As another example, the message dispatch application 402 may be configured to receive an API call from the application, and in the configuration process, may identify the owner of the application.

At step 502, the message dispatch application 402 can provide, to an application owner, client user access permissions, establishing the application owner as a client user 420. The access filter 422, as a component of the message dispatch application 402, can thereby filter access to make modification requests 416 to modify or generate custom templates 404 associated with the client user 420. The access filter 422 may create different access permissions based on the application owned by the application owner, allowing for multiple application owners to have access restricted to templates associated with their own respective software. Additionally, access filter 422 can allow the application owner, or another client user 420, to grant client user access permissions to other users. For instance, an application owner may wish to delegate the ability to generate custom templates 404 for their application to additional users such as system administrators, team developers, or others trusted by the application owner.

At step 503, the message dispatch application 402 receives a modification request 416, wherein the modification request 416 includes a modification to one or more of a static data element 408, a channel configuration data element 410, or a dynamic data element 412 of one or more templates. In some examples, other modification requests may be made, for instance, modifications to a data formatting element 414. The client user 420 generating the request can initiate the modification request 416 with respect to a default, predefined template and then generate a custom template 404 based on the modification request 416. The template database 406 may store a variety of default templates for access by any client user 420 with client user access permissions, wherein the client user 420 is free to select the template to initiate modification requests 416.

At step 504, the message dispatch application 402 generates a custom template 404 based in part on the modification request 416. The message dispatch application 402 may further generate the custom template 404 based on other data. For instance, the message dispatch application 402 may determine the client user 420 initiating the modification request 416 and generate the custom template with metadata indicating the client owner who submitted the modification request 416.

At step 505, the message dispatch application 402 may display a preview 418 of the custom template 404 based on modifications made to one or more of the elements 408-414. The preview 418 of the custom template 404 can include a preview of the custom template 404 generating a channel-specific message based on a modification made to one of elements 408-414. The preview 418 may be displayed through an interface 424. The preview 418 may be “in real-time” wherein the preview is generated in response to each modification request 416 received by the message dispatch application. Alternatively, the preview 418 may be generated in response to a request for previewing the custom template. The preview 418 may be validated with a test message. The preview 418 and or the validating test message may allow the user to validate the functionality of the custom template 404 so that the user may publish or deploy the custom template 404 after validation.

At step 506, the message dispatch application 402 may receive approval to deploy the custom template 404 into the template database 406. The approval may be received from input by a client user 420 into the interface 424. Thus, once a client user 420 is satisfied with the functionality of the custom template, 404, the client user can deploy the custom template 404 into the template database. In some embodiments, steps 505 and 506 may not be performed, and instead, the message dispatch application can resume at step 507.

At step 507, the message dispatch application 402 deploys the custom template 404 in the template database 406. Prior to deployment, templates, such as custom template 404, may be stored in the template database 406, but not executed by messaging clients 104. For instance, prior to deployment, a messaging client 104 transmitting a model data 106 that otherwise might trigger the message dispatch application 402 to receive the template, will not receive the template. After deployment into the template database 406, the custom template 404 may be selected by the message dispatch application 402 according to the procedures described within the disclosure so that the message dispatch application 402 can generate channel-specific messages for display on specified graphical user interfaces associated with any given channel.

### Example Computing System for Implementing the Message Dispatch Application

Any suitable computing system or group of computing systems can be used for performing the operations described herein. For example, FIG. 6 illustrates a block diagram for an example computing environment capable of executing the described systems and methods, according to certain embodiments.

The depicted example of a computing system 602 includes one or more processors 606 communicatively coupled to one or more memory devices 604. The processor 606 executes computer-executable program code or accesses information stored in the memory device 604. Examples of processor 606 include a microprocessor, an application-specific integrated circuit (“ASIC”), a field-programmable gate array (“FPGA”), or other suitable processing device. The processor 606 can include any number of processing devices, including one.

The memory device 604 includes any suitable non-transitory computer readable medium for storing the message dispatch application 622, template database 624 and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 602 may also include a number of external or internal devices such as input or output devices. For example, the computing system 602 is shown with an input/output (“I/O”) interface 608 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-8. The program code includes operations related to, for example, receiving message calls from a messaging client, generating or modifying custom templates, and processing message client inputs into the template, or other suitable applications or memory structures that perform one or more operations described herein. The program code may be resident in the memory device 604 or any suitable non-transitory computer-readable medium and may be executed by the processor 606 or any other suitable processor. In some embodiments, the program code described above, the message dispatch application 622, the template database 624, model data 628, and other received or determined values or data objects are stored in the memory device 604, as depicted in FIG. 6. In additional or alternative embodiments, one or more of the message dispatch application 622, the template database 624, model data 628, and other received or determined values or data objects and the program code described above are stored in one or more memory devices accessible via a data network, such as a memory device accessible via a cloud service.

The computing system 602 depicted in FIG. 6 also includes at least one network interface 612. The network interface 612 includes any device or group of devices suitable for establishing a wired or wireless data connection to one or more data networks 614 such as viewing applications 620 including user interfaces. Non-limiting examples of the network interface 612 include an Ethernet network adapter, a modem, and/or the like. A remote communication service 618 is connected to the computing system 602 via network 612 and can perform some of the operations described herein including generating templates or receiving messaging data and applying the messaging data to a specified template. The computing system 602 is able to communicate with one or more of the remote communication service 618 and the message dispatch application 622 using the network interface 610. Although FIG. 6 depicts the message dispatch application 622 as connected to computing system 602 via the networks 612, other embodiments are possible, including the message dispatch application 622 running as a program in the memory 604 of computing system 602.

### Advantages of Systems and Methods for a Message Dispatch Application

The described systems and methods provide unconventional benefits to the technical field of service based message processing and dispatch. Messaging client software applications can generate a significant amount of data that needs to be processed and transmitted across a variety of different software services and API channels. Traditionally, this process was resource intensive, requiring substantial recoding due to prior methods' relative inflexibility. The described message dispatch application can improve the field of message dispatch and transmission by providing new techniques for analyzing and processing data internal to a model data such as a JSON or HTML file and automatically inserting portions of the model data into a channel-specific message capable of being displayed on a graphical user interface. The template database, storing templates with programmable logic may be further used by the message dispatch application to improve the process of generating channel-specific messages.

The message dispatch application provides for improved message transmission across a variety of user interfaces. Each template, and its associated elements such as the dynamic data element, the channel configuration data element, and the data formatting element, all specify the manner in which portions of model data received from a messaging client are to be displayed on a graphical user interface. How a channel-specific message is displayed on its associated channel interface will vary depending on the template received by the message dispatch application. Moreover, the message dispatch application provides a simplified interface for client users to generate custom templates to be deployed in the template database. Client users can select from preexisting default templates, modify the templates to create custom templates, and deploy the custom templates into the template database. This template generation process obscures the complex process of manually coding processes for dispatching model data onto a variety of graphical user interfaces.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving, from a messaging client, model data;
receiving, from a database, a structured template, the database comprising one or more templates that each comprise a static data element, a dynamic data element, and a channel configuration data element;
generating a channel-specific message by applying the model data to the structured template; and
transmitting, to a service associated with the channel configuration data element, the channel-specific message.

2. The method of claim 1, further comprising, outputting the channel-specific message to a graphical user interface.

3. The method of claim 1 further comprising:
receiving a modification request, wherein the modification request includes a modification to one or more of the static data element, the dynamic data element, or the channel configuration data element of the one or more templates;
generating a custom template based in part on the modification request; and
deploying the custom template in the template database.

4. The method of claim 3, further comprising, receiving an application associated with an application owner; and
providing, to the application owner, client user access permissions.

5. The method of claim 3, further comprising, prior to deploying the custom template in the template database:
displaying a preview of the custom template; and
receiving approval to deploy the custom template in the database.

6. The method of claim 1, wherein the channel configuration data element includes channel-identifier data, and receiving the structured template from the database is based in part on the channel-identifier data.

7. The method of claim 1, wherein generating the channel-specific message comprises retrieving, from the model data, target variable data, and inserting the target variable data into the dynamic data element.

8. The method of claim 7, wherein generating the channel-specific message further comprises:
modifying the target variable data based in part on the channel configuration data element to generate modified target variable data; and
inserting the modified target variable data into the dynamic data element.

9. The method of claim 1, wherein the structured template further includes a data formatting element; and generating the channel-specific message includes modifying the model data based in part on the data formatting element.

10. The method of claim 1, wherein the messaging client generates an API call, and the API call generates the model data.

11. A system comprising:
one or more processors configured to:
receive, from a messaging client, model data;
receive, from a database a structured template, the database comprising one or more templates that each comprise a static data element, a dynamic data element, and a channel configuration data element;
generate a channel-specific message by applying the model data to the structured template; and
transmit, to a service associated with the channel configuration data element, the channel-specific message.

12. The system of claim 11, wherein the one or more processors are further configured to:
output the channel-specific message to a graphical user interface.

13. The system of claim 11, wherein the one or more processors are further configured to:
receive a modification request, wherein the modification request includes a modification to one or more of the static data element, the dynamic data element, or the channel configuration data element of the one or more templates;
generate a custom template based in part on the modification request; and
deploy the custom template in the template database.

14. The system of claim 13, wherein the one or more processors are further configured to:
receive an application associated with an application owner; and
provide, to the application owner, client user access permissions.

15. The system of claim 13, wherein the one or more processors are further configured to:
prior to deploying the custom template in the database:
display a preview of the custom template; and
receive approval to deploy the custom template into the database.

16. The system of claim 11, wherein the channel configuration data element includes channel-identifier data, and receiving the structured template from the database is based in part on the channel-identifier data.

17. The system of claim 11, wherein generating the channel-specific message comprises retrieving, from the model data, target variable data, and inserting the target variable data into the dynamic data element.

18. The system of claim 17, wherein the one or more processors are further configured to, in generating the channel-specific message:
modify the target variable data based in part on the channel configuration data element to generate modified target variable data; and
insert the modified target variable data into the dynamic data element.

19. The system of claim 11, wherein the structured template further includes a data formatting element; and generating the channel-specific message includes modifying the model data based in part on the data formatting element.

20. A non-transitory computer readable medium comprising instructions that when executed by one or more processors cause the one or more processors to:
receive, from a messaging client, model data;
receive, from a database a structured template, the database comprising one or more templates that each comprise a static data element, a dynamic data element, and a channel configuration data element;
generate a channel-specific message by applying the model data to the structured template; and
transmit, to a service associated with the channel configuration data element, the channel-specific message.
